(19) United States
(12) Patent Application Publication
(10) Pub. No.: US 2026/0004618 A1
(43) Pub. Date: Jan. 1, 2026

(54) INFORMATION COMMUNICATION SYSTEM FOR VEHICLE

(71) Applicant: SUBARU CORPORATION, Tokyo (JP)

(72) Inventor: Tomoyuki KITAMURA, Tokyo (JP)

(21) Appl. No.: 19/228,877

(22) Filed: Jun. 5, 2025

(30) Foreign Application Priority Data
Jun. 26, 2024 (JP) 2024-102850

(51) Int. Cl. G07C 5/00

(52) U.S. Cl. CPC G07C 5/008

(57) ABSTRACT

An information communication system for a vehicle includes an in-vehicle device, a mobile communication terminal, and a control server. The in-vehicle device includes a vehicle communicator that performs communication using a first communication standard, and a vehicle controller. The mobile communication terminal includes a first terminal communicator that performs communication using the first communication standard, a second terminal communicator that performs communication using a second communication standard, a display, and a terminal controller. The control server includes a server communicator that performs communication using the second communication standard. The vehicle controller transmits, upon detection of an abnormality in a vehicle, abnormality information for the vehicle from the vehicle communicator to the first terminal communicator. The terminal controller, upon receipt of the abnormality information, causes the display to display information extracted from the abnormality information, and transmits the abnormality information from the second terminal communicator to the server communicator.

### CROSS-REFERENCE TO RELATED APPLICATIONS

The present application claims priority from Japanese Patent Application No. 2024-102850 filed on Jun. 26, 2024, the entire contents of which are hereby incorporated by reference.

### BACKGROUND

The present disclosure relates to an information communication system for a vehicle that uses a mobile communication terminal.

In recent years, an information communication system has been put into practical use in which information communication is performed between an in-vehicle device and a control server or the like located outside a vehicle when an abnormality occurs due to malfunctioning of the vehicle. For example, Japanese Unexamined Patent Application Publication (JP-A) No. 2021-24363 discloses a technique for, when an abnormality in a vehicle is detected, performing communication based on a first communication method via a base station by using a first communication unit mounted in the vehicle to transmit abnormality information to a predetermined server. JP-A No. 2021-24363 further discloses a technique for, when communication using the first communication unit is not available, requesting a terminal located near the vehicle to transmit the abnormality information to the server by proxy, by using a second communication unit that is mounted in the vehicle and allows terminal-to-terminal direct communication.

### SUMMARY

An aspect of the present disclosure provides an information communication system for a vehicle. The information communication system includes an in-vehicle device, a mobile communication terminal, and a control server. The in-vehicle device includes a vehicle communicator and a vehicle controller. The vehicle communicator is configured to perform communication using a first communication standard that does not involve any base station. The mobile communication terminal includes a first terminal communicator, a second terminal communicator, a display, and a terminal controller. The first terminal communicator is configured to perform communication using the first communication standard. The second terminal communicator is configured to perform communication using a second communication standard that involves a base station. The display is configured to display information to a user. The control server includes a server communicator. The server communicator is configured to perform communication using the second communication standard. The vehicle controller is configured to, in response to detection of an abnormality in a vehicle, transmit abnormality information on the abnormality in the vehicle from the vehicle communicator to the first terminal communicator of the mobile communication terminal registered as being paired with the in-vehicle device. The terminal controller is configured to, in response to receipt of the abnormality information from the in-vehicle device, cause the display to display information extracted from the abnormality information, and transmit the abnormality information from the second terminal communicator to the server communicator.

An aspect of the present disclosure provides an information communication system for a vehicle. The information communication system includes an in-vehicle device, a mobile communication terminal, and a control server. The in-vehicle device includes a vehicle communication device and a vehicle processor. The vehicle communication device is configured to perform communication using a first communication standard that does not involve any base station. The mobile communication terminal includes a first terminal communication device, a second terminal communication device, a display device, and a terminal processor. The first terminal communication device is configured to perform communication using the first communication standard. The second terminal communication device is configured to perform communication using a second communication standard that involves a base station. The display device is configured to display information to a user. The control server includes a server communication device. The server communication device is configured to perform communication using the second communication standard. The vehicle processor is configured to, in response to detection of an abnormality in a vehicle, transmit abnormality information on the abnormality in the vehicle from the vehicle communication device to the first terminal communication device of the mobile communication terminal registered as being paired with the in-vehicle device. The terminal processor is configured to, in response to receipt of the abnormality information from the in-vehicle device, cause the display device to display information extracted from the abnormality information, and transmit the abnormality information from the second terminal communication device to the server communication device.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic configuration diagram of an information communication system for a vehicle;

FIG. 2 is a flowchart illustrating an abnormality handling control routine to be performed in an in-vehicle device when an abnormality occurs in a vehicle;

FIG. 3 is a flowchart illustrating an abnormality handling control routine to be performed in a mobile communication terminal when an abnormality occurs in the vehicle;

FIG. 4 is a flowchart illustrating an abnormality handling control routine to be performed in a control server when an abnormality occurs in the vehicle;

FIG. 5 is an explanatory diagram illustrating a state transition in handling of an abnormality in the vehicle;

FIG. 6 is an explanatory diagram illustrating a display example on a display device of the mobile communication terminal; and

FIG. 7 is an explanatory diagram illustrating a display example on the display device of the mobile communication terminal.

### DETAILED DESCRIPTION

The above-described technique disclosed in JP-A No. 2021-24363 is basically for transmitting the abnormality information to the control server or the like by using the first communication unit. Therefore, when an abnormality occurs in a vehicle, a user such as a driver who drives the vehicle can obtain just the limited information displayed on an instrument panel or the like, and thus has difficulty obtaining specific abnormality information.

The technique disclosed in JP-A No. 2021-24363 is for transmitting the abnormality information by proxy by using an unspecified terminal, when communication using the first communication unit is not available. Therefore, with the technique disclosed in JP-A No. 2021-24363, it may be difficult to transmit information such as an analysis result of the abnormality information from the control server or the like to the user.

It is desirable to provide an information communication system for a vehicle that is capable of appropriately informing a user of abnormality information communicated between a vehicle and a control server.

An embodiment of one aspect of the present disclosure will be described in detail below with reference to the drawings. In the drawings used for the description below, the scales of respective components vary to make the individual components have a size recognizable in the drawings. Therefore, the present disclosure is not limited merely to the number of components, the shapes of the components, the size ratios of the components, and the relative positional relationships between the components illustrated in these drawings.

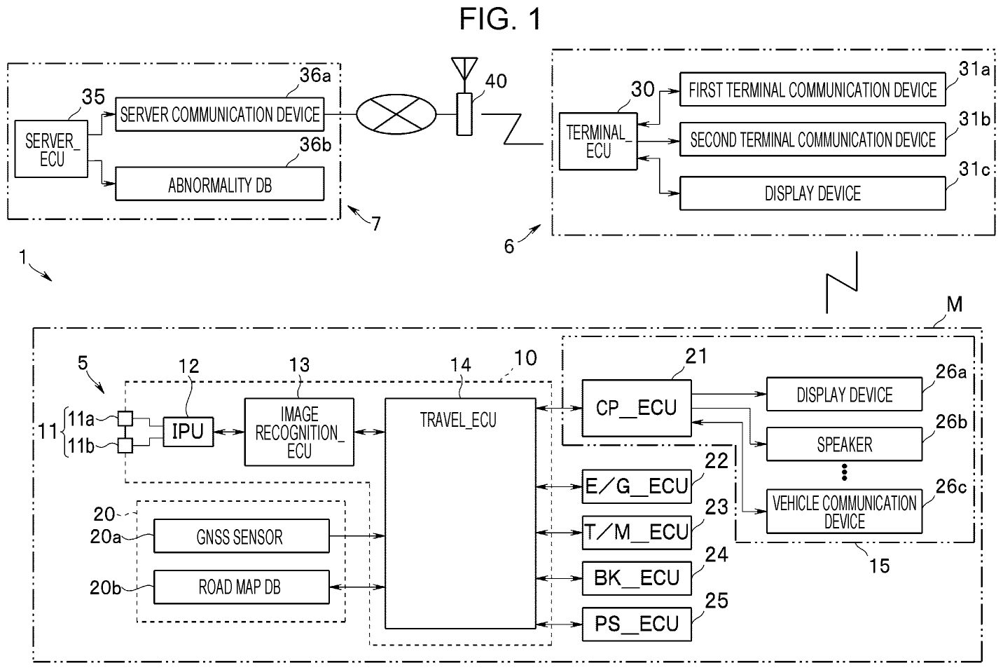

As illustrated in FIG. 1, an information communication system 1 for a vehicle includes, for example, an in-vehicle device 15 included in a driving assistance apparatus 5, a mobile communication terminal 6, and a control server 7.

The driving assistance apparatus 5 is mounted on a vehicle M. The driving assistance apparatus 5 includes, for example, a camera unit 10. The camera unit 10 is fixed to an upper central area of a front portion of a vehicle cabin of the vehicle M.

The camera unit 10 includes, for example, a stereo camera 11, an image processing unit (IPU) 12, an image recognition unit (image recognition_ECU) 13, and a travel control unit (travel_ECU) 14.

The stereo camera 11 includes a main camera 11a and a sub camera 11b. The main camera 11a and the sub camera 11b perform stereo imaging from different viewpoints at imaging cycles synchronized with each other to obtain travel environment information of an outside area in front of the vehicle M.

The IPU 12 performs predetermined image processing on the travel environment information obtained by the stereo camera 11 through imaging. For example, the IPU 12 determines distance information from an amount of positional deviation between corresponding edges of left and right images. The IPU 12 thus generates image information (distance image information) including the distance information.

The image recognition_ECU 13 recognizes the travel environment information of the vehicle M, based on information such as the distance image information input from the IPU 12. For example, the image recognition_ECU 13 performs processing such as predetermined pattern matching on the distance image information. The image recognition_ECU 13 thus recognizes lane lines on the road. The image recognition_ECU 13 recognizes various three-dimensional objects such as guardrails, curbs, and a median strip extending along the road, nearby vehicles, and pedestrians.

The travel_ECU 14 is a control unit for centrally controlling the driving assistance apparatus 5.

The travel_ECU 14 is coupled to various sensors such as a locator unit 20. The travel_ECU 14 is also coupled to various control units such as a cockpit control unit (CP_ECU) 21, an engine control unit (E/G_ECU) 22, a transmission control unit (T/M_ECU) 23, a brake control unit (BK_ECU) 24, and a power steering control unit (PS_ECU) 25 via an in-vehicle communication network such as a controller area network (CAN).

The locator unit 20 includes a Global Navigation Satellite System (GNSS) sensor 20a and a high-precision road map database (road map DB) 20b.

The GNSS sensor 20a receives positioning signals transmitted from a plurality of positioning satellites. The GNSS sensor 20a thus measures the position (such as latitude, longitude, and altitude) of the vehicle M.

The road map DB 20b is a mass storage medium such as a hard disk drive (HDD). The road map DB 20b stores high-precision road map information (dynamic map). The road map information includes, for example, lane data for use in automated driving such as lane width data, lane center position coordinate data, travel azimuth angle data of the lane, and speed limit data. The lane data is stored for each lane on the road map at intervals of several meters. The road map DB 20b further stores, for example, data associated with the lane data such as traffic light data.

For example, based on a request signal from the travel_ECU 14, the road map DB 20b outputs, as the travel environment information, to the travel_ECU 14, road map information for a range set based on the position of the vehicle M measured by the GNSS sensor 20a.

The CP_ECU 21 is coupled to human machine interfaces (HMIs) installed around a driver's seat, for example, a display device 26a and a speaker 26b.

When receiving various kinds of information related to driving assistance control and the like from the travel_ECU 14, the CP_ECU 21 appropriately notifies the driver of the received information. Such a notification is made by using the display device 26a through display and by using the speaker 26b through audio output, for example.

Based on a signal such as a control signal from the travel_ECU 14 or a detection signal from each of various sensors, the E/G_ECU 22 performs drive control on a throttle actuator (not illustrated) or the like. The E/G_ECU 22 thus adjusts an intake air amount of an engine to generate a desired engine output. The E/G_ECU 22 also outputs signals for an accelerator opening and the like detected by the various sensors to the travel_ECU 14. The E/G_ECU 22 performs an abnormality diagnosis (malfunctioning diagnosis) of the engine, based on the signals obtained by the various sensors through detection.

The T/M_ECU 23 performs hydraulic control on a hydraulic control circuit (not illustrated) and the like, based on a signal such as an engine torque signal estimated by the E/G_ECU 22 or a detection signal from each of various sensors. The T/M_ECU 23 thus operates components of an automatic transmission such as frictional engagement elements and pulleys to change an engine output at a desired transmission gear ratio. The T/M_ECU 23 outputs signals for a shift position and the like detected by the various sensors to the travel_ECU 14. The T/M_ECU 23 performs an abnormality diagnosis (malfunctioning diagnosis) of the automatic transmission, based on the signals obtained by the various sensors through detection.

Based on a signal such as a control signal from the travel_ECU 14 or a detection signal from each of various sensors, the BK_ECU 24 performs drive control on a brake actuator (not illustrated) or the like. The BK_ECU 24 thus appropriately generates, at respective wheels, braking forces for performing forced braking control, yaw rate control, and the like on the vehicle M. The BK_ECU 24 outputs signals for a brake operation state, a yaw rate, a longitudinal acceleration, and a vehicle speed (vehicle speed of the vehicle M) detected by the various sensors to the travel_ECU 14. The BK_ECU 24 performs an abnormality diagnosis (malfunctioning diagnosis) of a braking system, based on the signals obtained by the various sensors through detection.

Based on a signal such as a control signal from the travel_ECU 14 or a detection signal from each of various sensors, the PS_ECU 25 performs drive control on an electric power steering motor (not illustrated) or the like. The PS_ECU 25 thus generates a steering torque for a steering mechanism. The PS_ECU 25 outputs signals for a steering torque, a steering angle, and the like detected by the various sensors to the travel_ECU 14. The PS_ECU 25 performs an abnormality diagnosis (malfunctioning diagnosis) of a steering system, based on the signals obtained by the various sensors through detection.

The travel_ECU 14 performs driving assistance control on the vehicle M, based on information such as driving information of the vehicle M input from various in-vehicle sensors and the travel environment information input from the image recognition_ECU 13, the locator unit 20, and the like.

For driving assistance control, the travel_ECU 14 calculates, for example, control signals for the respective ECUs 21 to 25. The travel_ECU 14 thus implements driving assistance control in which adaptive cruise control (ACC), active lane keep centering (ALKC), active lane keep bouncing (ALKB), and the like are appropriately combined.

In the driving assistance apparatus 5, the CP_ECU 21 is further coupled to a vehicle communication device 26c. In one embodiment, the vehicle communication device 26c may serve as a vehicle communicator.

The vehicle communication device 26c is a communication device that performs communication using a short-range wireless communication standard such as Bluetooth (registered trademark). That is, the vehicle communication device 26c can perform wireless communication using a communication standard (first communication standard) that does not involve any base station.

The vehicle communication device 26c, together with the CP_ECU 21 and other components, constitutes the in-vehicle device 15. The in-vehicle device 15 is a device that performs information communication with the control server 7 or the like when an abnormality occurs in the vehicle M.

When the CP_ECU 21 functions as the in-vehicle device 15, the CP_ECU 21 corresponds to a specific example of a vehicle controller (vehicle processor). That is, the CP_ECU 21 collects results of the abnormality diagnosis performed by the respective ECUs 22 to 25 and the like. When the collected abnormality diagnosis results include abnormality information of the vehicle M, the CP_ECU 21 records the abnormality information. The CP_ECU 21 further collects information associated with the abnormality information from the image recognition_ECU 13, the locator unit 20, the ECUs 22 to 25, and the like.

The CP_ECU 21 displays the acquired abnormality information as an indicator or the like using the display device 26a.

The abnormality information supplied from each of the ECUs 22 to 25 and the like includes, for example, an error code assigned in advance in accordance with the state of the abnormality. The associated information collected by the CP_ECU 21 includes, for example, a total mileage of the vehicle M at the time of abnormality occurrence, a date and time and a location at the time of abnormality occurrence, a system activation time of the vehicle M at the time of abnormality occurrence, travel environment information at the time of abnormality occurrence, vehicle speed log information up to the time of abnormality occurrence, steering angle log information up to the time of abnormality occurrence, and brake operation log information up to the time of abnormality occurrence.

The CP_ECU 21 communicates with the mobile communication terminal 6 using the vehicle communication device 26c. The vehicle communication device 26c can thus transmit the abnormality information and the associated information acquired by the CP_ECU 21 to the mobile communication terminal 6. In this case, the CP_ECU 21 permits the vehicle communication device 26c to communicate with the mobile communication terminal 6 that has established coupling with the in-vehicle device 15.

The mobile communication terminal 6 is, for example, a smartphone, a tablet terminal, a wearable terminal, or a mobile phone terminal. The mobile communication terminal 6 includes a terminal control unit (terminal_ECU) 30. In one embodiment, the terminal control unit (terminal_ECU) 30 may serve as a terminal controller (terminal processor).

The terminal control unit 30 is coupled to, for example, a first terminal communication device 31a, a second terminal communication device 31b, and a display device 31c. In one embodiment, the first terminal communication device 31a may serve as a first terminal communicator. In one embodiment, the second terminal communication device 31b may serve as a second terminal communicator. In one embodiment, the display device 31c may serve as a display.

The first terminal communication device 31a is a communication device that performs communication using a short-range wireless communication standard such as Bluetooth (registered trademark). That is, the first terminal communication device 31a can perform wireless communication using a communication standard (first communication standard) that does not involve any base station.

The second terminal communication device 31b is a communication device that performs communication using a non-short-range wireless communication standard. That is, the second terminal communication device 31b can perform wireless communication using a communication standard (second communication standard) that involves a base station 40.

The display device 31c includes, for example, a touch-panel liquid crystal display. The display device 31c displays various kinds of information to a user.

The terminal_ECU 30 performs communication with the in-vehicle device 15 using the first terminal communication device 31a. The first terminal communication device 31a can thus receive the abnormality information and the associated information from the in-vehicle device 15. In this case, the terminal_ECU 30 permits the first terminal communication device 31a to communicate with the in-vehicle device 15 when coupling has been established between the mobile communication terminal 6 and the in-vehicle device 15.

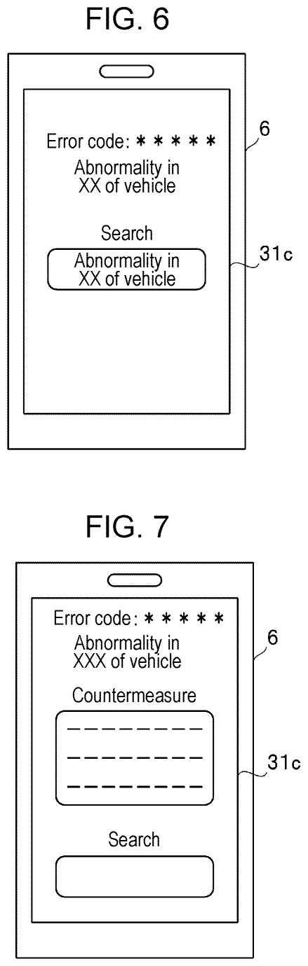

The terminal_ECU 30 causes the display device 31c to display the abnormality information received from the in-vehicle device 15. In this case, the terminal_ECU 30 causes the display device 31c to display part of the abnormality information received from the in-vehicle device 15. For example, as illustrated in FIG. 6, the terminal_ECU 30 causes the display device 31c to display an error code and a brief description of the abnormality from the abnormality information. In some embodiments, the terminal_ECU 30 displays a search screen that allows a user to search for a specific content of the abnormality or the like.

The terminal_ECU 30 communicates with the control server 7 using the second terminal communication device 31b. The second terminal communication device 31b can thus transmit all of the abnormality information and the associated information received from the in-vehicle device 15 to the control server 7. When an information search is performed using the search screen, the terminal_ECU 30 can transmit an information search request to the control server 7 or the like. In this case, the terminal_ECU 30 transmits terminal information for identifying the mobile communication terminal 6 as the associated information to the control server 7.

The terminal_ECU 30 can receive various kinds of information transmitted from the control server 7 by communication using the second terminal communication device 31b. As described later, the information received from the control server 7 can include various kinds of information such as countermeasures against an abnormality in the vehicle M and a search result of the information search. In this case, for example, as illustrated in FIG. 7, the terminal_ECU 30 causes the display device 31c to display information on the countermeasures against the abnormality (and information on the search result) together with the error code and the brief description of the abnormality.

The control server 7 is installed at a dealer or the like. The control server 7 includes a server control unit (server_ECU) 35. In one embodiment, the server control unit (server_ECU) 35 may serve as a server controller (server processor).

For example, the server_ECU 35 is coupled to, for example, a server communication device 36a and an abnormality database (abnormality DB) 36b. In one embodiment, the server communication device 36a may serve as a server communicator.

The server communication device 36a is a communication device that performs communication using a non-short-range wireless communication standard. That is, the server communication device 36a can perform communication using a communication standard (second communication standard) that involves the base station 40.

The abnormality DB 36b is a mass storage medium such as an HDD. The abnormality DB 36b stores explanations of various error codes, countermeasures against abnormalities, and the like.

The server_ECU 35 communicates with the mobile communication terminal 6 using the server communication device 36a. The control server 7 can thus receive various kinds of information transmitted from the mobile communication terminal 6. That is, the control server 7 can receive various kinds of information transmitted from the in-vehicle device 15 via the mobile communication terminal 6. The control server 7 can thus collect information such as the abnormality information of the vehicle M and the associated information.

The server_ECU 35 appropriately analyzes the collected abnormality information of the vehicle M. In the analysis of the abnormality information, the server_ECU 35 can take the associated information, the information stored in the abnormality DB 36b, and the like into account. A result of this analysis includes, for example, information such as countermeasures to be taken by the user against the abnormality. The server_ECU 35 can transmit the analysis result that is based on the abnormality information to the mobile communication terminal 6 by communication using the server communication device 36a.

The server_ECU 35 can receive a search request about an abnormality from the mobile communication terminal 6 by communication using the server communication device 36a. When receiving the search request, the server_ECU 35 performs an information search on the abnormality DB 36b in accordance with the search request. The server_ECU 35 can transmit a search result for the search request to the mobile communication terminal 6 by communication using the server communication device 36a.

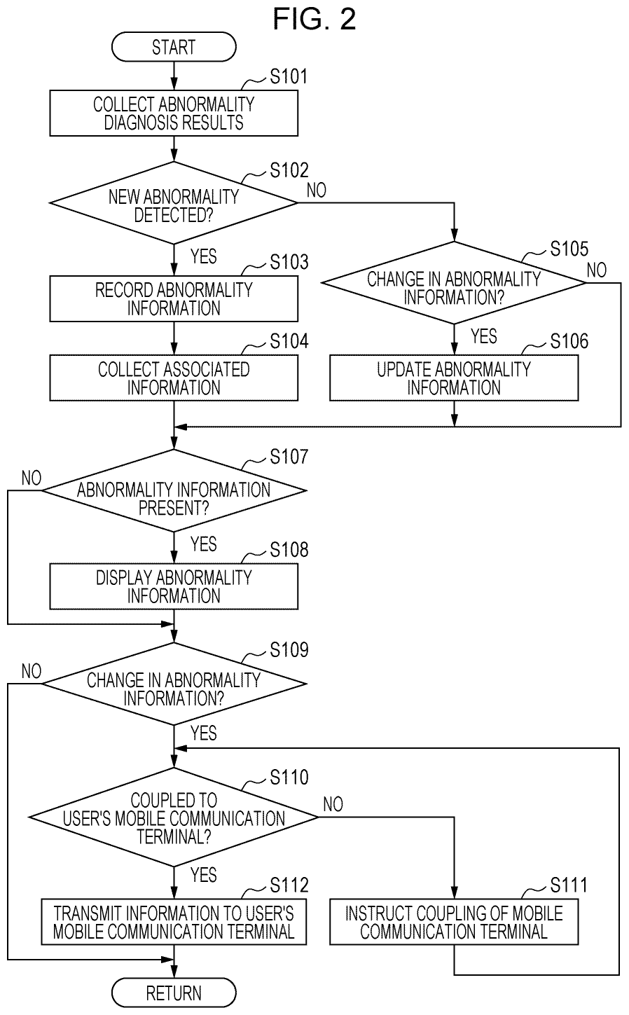

Abnormality handling control performed in the in-vehicle device when an abnormality occurs in a vehicle will be described in accordance with a flowchart of an abnormality handling control routine illustrated in FIG. 2. The CP_ECU 21 repeatedly performs this routine at intervals of a set time.

After the routine starts, the CP_ECU 21 collects abnormality diagnosis results from the ECUs 22 to 25 and the like in step S101.

In step S102, the CP_ECU 21 then checks whether a new abnormality is detected in the vehicle M, based on the collected abnormality diagnosis results and the like.

When the CP_ECU 21 determines in step S102 that a new abnormality is not detected (step S102: NO), the process proceeds to step S105.

On the other hand, when the CP_ECU 21 determines in step S102 that a new abnormality is detected (step S102: YES), the process proceeds to step S103.

In step S103, the CP_ECU 21 records abnormality information on the detected new abnormality in a storage or the like.

In step S104, the CP_ECU 21 collects various kinds of information associated with the abnormality information from the image recognition_ECU 13, the locator unit 20, the ECUs 22 to 25, and the like.

After the process proceeds from step S102 to step S105, the CP_ECU 21 checks whether there is a change in the abnormality information recorded in the storage or the like. The case where the abnormality information changes corresponds to, for example, a case where the abnormality is improved or resolved as a result of the user or the like dealing with the abnormality in the vehicle M.

When the CP_ECU 21 determines in step S105 that there is no change in the abnormality information (step S105: NO), the process proceeds to step S107.

On the other hand, when the CP_ECU 21 determines in step S105 that there is a change in the abnormality information (step S105: YES), the process proceeds to step S106.

In step S106, the CP_ECU 21 updates the abnormality information recorded in the storage or the like. The process then proceeds to step S107. For example, when the abnormality indicated by the abnormality information recorded in the storage or the like is improved, the CP_ECU 21 rewrites the recorded abnormality information to abnormality information indicating the improvement. In this case, the CP_ECU 21 moves and stores the abnormality information before the improvement to an abnormality history folder or the like provided in the storage or the like. For example, when the abnormality indicated by the abnormality information recorded in the storage or the like is resolved, the CP_ECU 21 moves and stores the abnormality information to the abnormality history folder or the like.

After the process proceeds from step S104, step S105, or step S106 to step S107, the CP_ECU 21 checks whether abnormality information currently recorded in the storage or the like is present.

When the CP_ECU 21 determines in step S107 that the abnormality information is not present (step S107: NO), the process proceeds to step S109.

On the other hand, when the CP_ECU 21 determines in step S107 that abnormality information is present (step S107: YES), the process proceeds to step S108.

In step S108, for example, the CP_ECU 21 displays an indicator for the abnormality information on the display device 26a or the like. The process then proceeds to step S109.

After the process proceeds from step S107 or step S108 to step S109, the CP_ECU 21 checks whether the current abnormality information has changed from the abnormality information previously recorded in the storage or the like. The case where the abnormality information changes corresponds to, for example, a case where abnormality information is added due to detection of a new abnormality. The case where the abnormality information changes corresponds to, for example, a case where the abnormality is improved or resolved as a result of the user or the like dealing with the abnormality in the vehicle M.

When the CP_ECU 21 determines in step S109 that the abnormality information has not changed (step S109: NO), the CP_ECU 21 exits the routine without performing any processing.

On the other hand, when the CP_ECU 21 determines in step S109 that the abnormality information has changed (step S109: YES), the process proceeds to step S110.

In step S110, the CP_ECU 21 checks whether the user's mobile communication terminal 6 is coupled to the in-vehicle device 15 for communication.

When the CP_ECU 21 determines in step S110 that the user's mobile communication terminal 6 is not coupled (step S110: NO), the process proceeds to step S111.

In step S111, the CP_ECU 21 instructs the user to establish coupling between the in-vehicle device 15 and the mobile communication terminal 6, for example, through display using the display device 26a or audio output using the speaker 26b. The process then returns to step S110.

On the other hand, when the CP_ECU 21 determines in step S110 that the user's mobile communication terminal 6 is coupled (step S110: YES), the process proceeds to step S112.

In step S112, the CP_ECU 21 transmits the abnormality information and the associated information to the user's mobile communication terminal 6 using the vehicle communication device 26c, and then exits the routine.

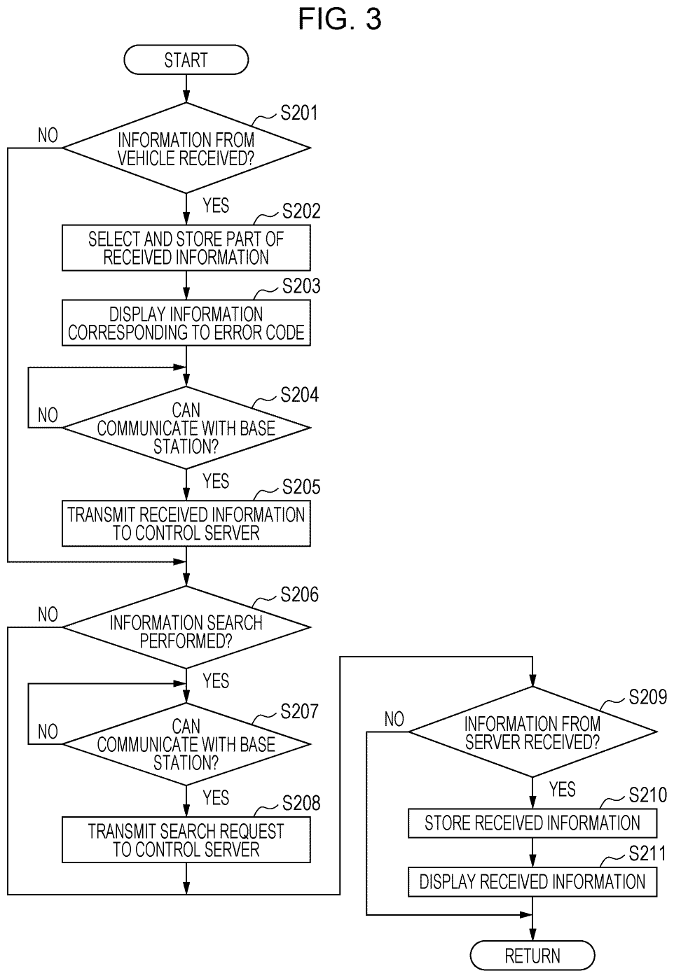

Abnormality handling control performed in the mobile communication terminal 6 when an abnormality occurs in the vehicle will be described in accordance with a flowchart of an abnormality handling control routine illustrated in FIG. 3. The terminal_ECU 30 repeatedly performs this routine at intervals of a set time.

After the routine starts, the terminal_ECU 30 checks whether information (such as the abnormality information and the associated information) from the vehicle M is received.

When the terminal_ECU 30 determines in step S201 that no information is received from the vehicle M (step S201: NO), the process proceeds to step S206.

On the other hand, when the terminal_ECU 30 determines in step S201 that the information from the vehicle M is received (step S201: YES), the process proceeds to step S202.

In step S202, the terminal_ECU 30 selects part of the received information and stores the selected information in the storage or the like. In this case, the terminal_ECU 30 selects, for example, just enough information to identify the abnormality in the vehicle M, such as an error code, from the received information.

In step S203, the terminal_ECU 30 causes the display device 31c to display the abnormality information or the like corresponding to the error code (see, for example, FIG. 6). The process then proceeds to step S204.

In step S204, the terminal_ECU 30 checks whether communication with the base station 40 is available.

When the terminal_ECU 30 determines in step S204 that communication with the base station 40 is not available (step S204: NO), the terminal_ECU 30 waits without performing any processing.

On the other hand, when the terminal_ECU 30 determines in step S204 that communication with the base station 40 is available (step S204: YES), the process proceeds to step S205.

In step S205, the terminal_ECU 30 transmits (transfers) the information (such as the abnormality information and the associated information) received from the in-vehicle device 15 to the control server 7. The process then proceeds to step S206. In this case, for example, the terminal_ECU 30 adds the terminal information of the mobile communication terminal 6 to the information to be transmitted to the control server 7.

After the process proceeds from step S201 or step S205 to step S206, the terminal_ECU 30 checks whether an information search is performed by the user in the mobile communication terminal 6.

When the terminal_ECU 30 determines in step S206 that an information search is not performed (step S206: NO), the process proceeds to step S209.

On the other hand, when the terminal_ECU 30 determines in step S206 that an information search is performed (step S206: YES), the process proceeds to step S207.

In step S207, the terminal_ECU 30 checks whether communication with the base station 40 is available.

When the terminal_ECU 30 determines in step S207 that communication with the base station 40 is not available (step S207: NO), the terminal_ECU 30 waits without performing any processing.

On the other hand, when the terminal_ECU 30 determines in step S207 that communication with the base station 40 is available (step S207: YES), the process proceeds to step S208.

In step S208, the terminal_ECU 30 transmits a search request for information input by the user to the control server 7. The process then proceeds to step S209. In this case, for example, the terminal_ECU 30 adds the terminal information of the mobile communication terminal 6 to the information to be transmitted to the control server 7.

After the process proceeds from step S206 or step S208 to step S209, the terminal_ECU 30 checks whether information from the control server 7 is received.

When the terminal_ECU 30 determines in step S209 that no information is received from the control server 7 (step S209: NO), the terminal_ECU 30 exits the routine without performing any processing.

On the other hand, when the terminal_ECU 30 determines in step S209 that information from the control server 7 is received (step S209: YES), the process proceeds to step S210.

In step S210, the terminal_ECU 30 stores the information received from the control server 7.

In step S211, the terminal_ECU 30 displays the received information on the display device 31c (see, for example, FIG. 7), and then exits the routine.

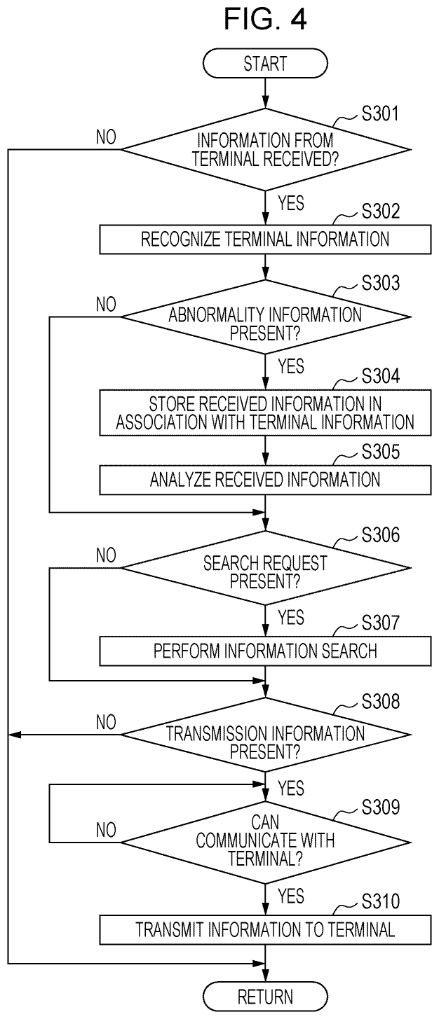

Abnormality handling control performed in the control server 7 when an abnormality occurs in the vehicle will be described in accordance with a flowchart of an abnormality handling control routine illustrated in FIG. 4. The server_ECU 35 repeatedly performs this routine at intervals of a set time.

After the routine starts, the server_ECU 35 checks whether information from the mobile communication terminal 6 is received in step S301.

When the server_ECU 35 determines in step S301 that no information is received from the mobile communication terminal 6 (step S301: NO), the server_ECU 35 exits the routine without performing any processing.

On the other hand, when the server_ECU 35 determines in step S301 that information from the mobile communication terminal 6 is received (step S301: YES), the process proceeds to step S302.

In step S302, the server_ECU 35 recognizes the terminal information included in the received information.

In step S303, the server_ECU 35 checks whether the received information received from the mobile communication terminal 6 includes abnormality information.

When the server_ECU 35 determines in step S303 that the received information does not include the abnormality information (step S303: NO), the process proceeds to step S306.

On the other hand, when the server_ECU 35 determines in step S303 that the received information includes the abnormality information (step S303: YES), the process proceeds to step S304.

In step S304, the server_ECU 35 stores the received information in the storage or the like in association with the terminal information.

In step S305, the server_ECU 35 analyzes the received information. That is, for example, the server_ECU 35 analyzes the abnormality information in consideration of the associated information received together with the abnormality information, the information stored in the abnormality DB 36b, and the like.

After the process proceeds from step S303 or step S305 to step S306, the server_ECU 35 checks whether the received information received from the mobile communication terminal 6 includes a search request.

When the server_ECU 35 determines in step S306 that the received information does not include a search request (step S306: NO), the process proceeds to step S308.

On the other hand, when the server_ECU 35 determines in step S306 that the received information includes a search request, the process proceeds to step S307.

In step S307, the server_ECU 35 performs an information search on the abnormality DB 36b in accordance with the search request.

After the process proceeds from step S306 or step S307 to step S308, the server_ECU 35 checks whether transmission information to be transmitted to the mobile communication terminal 6 is present. That is, the server_ECU 35 checks whether information transmittable to the mobile communication terminal 6 has been generated in step S305 or step S307 described above.

When the server_ECU 35 determines in step S308 that transmission information is not present (step S308: NO), the server_ECU 35 exits the routine without performing any processing.

On the other hand, when the server_ECU 35 determines in step S308 that transmission information is present (step S308: YES), the process proceeds to step S309.

In step S309, the server_ECU 35 checks whether communication with the mobile communication terminal 6 is available.

When the server_ECU 35 determines in step S309 that communication with the mobile communication terminal 6 is not available (step S309: NO), the server_ECU 35 waits without performing any processing.

On the other hand, when the server_ECU 35 determines in step S309 that communication with the mobile communication terminal 6 is available (step S309: YES), the process proceeds to step S310.

In step S310, the server_ECU 35 transmits the information generated in step S305 or step S307 to the mobile communication terminal 6 corresponding to the terminal information recognized in step S302, and then exits the routine.

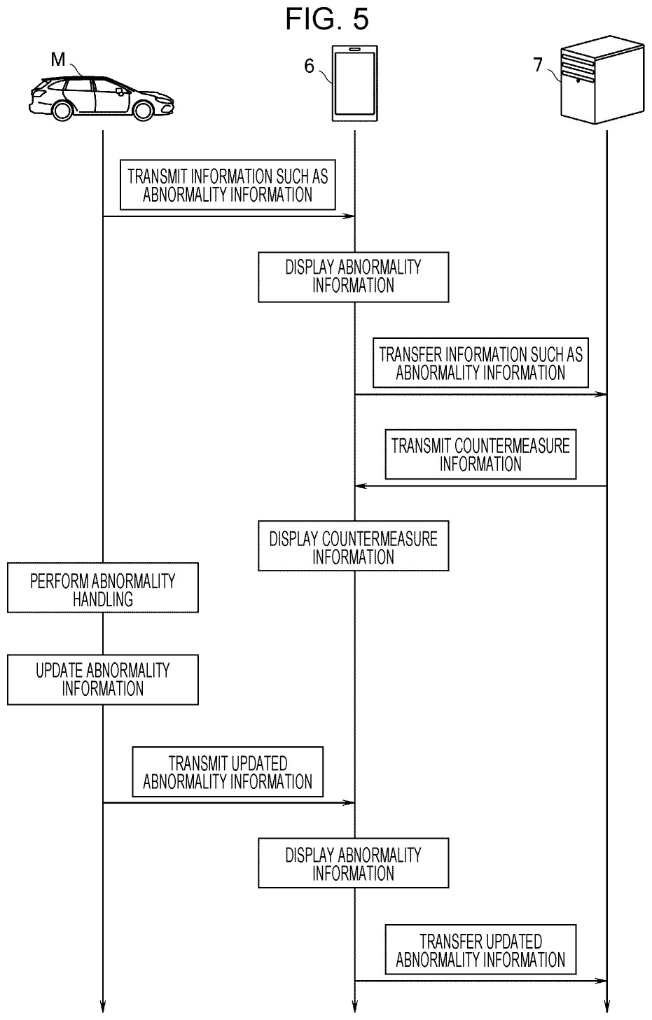

Through such control, for example, as illustrated in FIG. 5, when an abnormality occurs in the vehicle M, the CP_ECU 21 of the in-vehicle device 15 transmits information such as abnormality information to the mobile communication terminal 6 by communication using a short-range wireless communication standard. In this case, the CP_ECU 21 transmits the information such as the abnormality information to the mobile communication terminal 6 that has established coupling with the in-vehicle device 15.

When receiving the information such as the abnormality information, the terminal_ECU 30 of the mobile communication terminal 6 displays part of the received abnormality information on the display device 31c. In this case, the terminal_ECU 30 displays the abnormality that has occurred in the vehicle M on the display device 31c using specific text information or the like. The terminal_ECU 30 thus allows the user or the like to accurately recognize the abnormality that has occurred in the vehicle M.

The terminal_ECU 30 transmits all the information received from the in-vehicle device 15 to the control server 7, by communication using a non-short-range wireless communication standard. As described above, the mobile communication terminal 6 is involved in the information communication from the vehicle M to the control server 7. This allows a user holding the mobile communication terminal 6 to transmit the information such as the abnormality information to the control server 7 simply by getting out of the vehicle M and moving for a predetermined distance even when the vehicle M becomes unable to travel at a location where communication with the control server 7 is not available, for example.

At this time, the terminal_ECU 30 adds the terminal information to the information to be transmitted from the mobile communication terminal 6. The control server 7 thus acquires information on the user or the like that serves as an information transmission source, without requesting the user for user information.

The server_ECU 35 of the control server 7 transmits information (such as information on countermeasures against the abnormality) generated through analysis or the like of the abnormality information, to the mobile communication terminal 6 by communication using a non-short-range wireless communication standard. At this time, the server_ECU 35 uses the acquired terminal information to accurately transmit the information such as the countermeasure information to the user's mobile communication terminal 6.

The terminal_ECU 30 of the mobile communication terminal 6 causes the display device 31c to display the information such as the countermeasure information received from the control server 7. This allows the user or the like to obtain detailed information on countermeasures against the abnormality in the vehicle M.

Displaying the detailed countermeasure information on the mobile communication terminal 6 allows the user or the like to deal with the abnormality in the vehicle M when the abnormality in the vehicle M is minor.

After the user or the like takes the countermeasures against the abnormality, the CP_ECU 21 updates the abnormality information as needed, and transmits the updated abnormality information to the mobile communication terminal 6.

The terminal_ECU 30 then displays the updated abnormality information on the display device 31c. This allows the user or the like to immediately check the result of the countermeasures against the abnormality in the vehicle M.

The terminal_ECU 30 transmits the updated abnormality information to the control server 7. Thus, when the user or the like takes the countermeasures against the abnormality, the updated abnormality information is reflected in the control server 7.

According to the embodiment, the information communication system 1 includes the in-vehicle device 15, the mobile communication terminal 6, and the control server 7. The in-vehicle device 15 includes the vehicle communication device 26c and the CP_ECU 21. The vehicle communication device 26c performs communication using a short-range wireless communication standard that does not involve any base station. The mobile communication terminal 6 includes the first terminal communication device 31a, the second terminal communication device 31b, the display device 31c, and the terminal_ECU 30. The first terminal communication device 31a performs communication using the short-range wireless communication standard. The second terminal communication device 31b performs communication using a non-short-range wireless communication standard that involves a base station. The display device 31c displays information to a user. The control server 7 includes the server communication device 36a. The server communication device 36a performs communication using the non-short-range wireless communication standard. In response to detection of an abnormality in the vehicle M, the CP_ECU 21 transmits abnormality information on the abnormality in the vehicle M from the vehicle communication device 26c to the first terminal communication device 31a of the mobile communication terminal 6 registered as being paired with the in-vehicle device 15. In response to receipt of the abnormality information from the in-vehicle device 15, the terminal_ECU 30 causes the display device 31c to display information extracted from the abnormality information, and transmits the abnormality information from the second terminal communication device 31b to the server communication device 36a. Thus, the information communication system 1 can appropriately inform the user of the abnormality information communicated between the vehicle M and the control server 7.

That is, in the information communication system 1 according to the present embodiment, the mobile communication terminal 6 that has established coupling with the in-vehicle device 15 is involved in information communication performed between the in-vehicle device 15 and the control server 7. This allows the user or the like to be appropriately informed of the abnormality information as text or the like displayed on the display device 31c of the mobile communication terminal 6 used by the user or the like.

In this case, the abnormality information may include an error code. The terminal_ECU 30 may cause the display device 31c to display a search screen that allows a search for detailed information corresponding to the error code. This allows the user or the like to be quickly informed of detailed information of the abnormality information when the user or the like desires the detailed information.

The terminal_ECU 30 may attach information for identifying the mobile communication terminal 6 to the abnormality information when transmitting the abnormality information to the control server 7. This allows the server_ECU 35 to accurately transmit information such as a result of analysis to the user's mobile communication terminal 6 when the control server 7 performs the analysis on the abnormality information.

In the embodiment described above, the image recognition_ECU 13, the travel_ECU 14, the CP_ECU 21, the E/G_ECU 22, the T/M_ECU 23, the BK_ECU 24, the PS_ECU 25, the terminal_ECU 30, and the server_ECU 35 are implemented by a well-known microcomputer including a central processing unit (CPU) (processor), a random access memory (RAM), a read-only memory (ROM), a nonvolatile storage, and the like, and peripheral devices of the microcomputer. The ROM stores in advance, for example, programs to be executed by the CPU and fixed data such as data tables. All or some of the functions of the processor may be implemented by a logic circuit or an analog circuit. Processing of the various programs may be implemented by an electronic circuit such as a field programmable gate array (FPGA).

The disclosure described in the embodiment above is not limited to the embodiment. In the stage of implementation, various modifications can be implemented within the scope not departing from the idea of the disclosure. For example, the embodiment above describes an example of the configuration in which the first terminal communication device 31a performs wireless communication with the vehicle communication device 26c using a short-range wireless communication standard. Alternatively, the first terminal communication device 31a may perform wired communication with the vehicle communication device 26c. Further, the above-described embodiment includes disclosures in various stages. Various disclosures can be extracted from appropriate combinations of the disclosed multiple components.

For example, even though some components are deleted from all the components described in the embodiment, the configuration from which the components are deleted can be extracted as a disclosure as long as the described issue can be solved and the described effect can be obtained.

The information communication system for a vehicle according to the embodiment of the present disclosure is capable of appropriately informing a user of abnormality information communicated between the vehicle and the control server.

Each of the CP_ECU 21, the vehicle communication device 26c, the terminal_ECU 30, the first terminal communication device 31a, the second terminal communication device 31b, the server_ECU 35, and the server communication device 36a illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of a corresponding one of the CP_ECU 21, the vehicle communication device 26c, the terminal_ECU 30, the first terminal communication device 31a, the second terminal communication device 31b, the server_ECU 35, and the server communication device 36a. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. An information communication system for a vehicle, the information communication system comprising:
an in-vehicle device comprising:
a vehicle communicator configured to perform communication using a first communication standard that does not involve any base station; and
a vehicle controller;
a mobile communication terminal comprising:
a first terminal communicator configured to perform communication using the first communication standard;
a second terminal communicator configured to perform communication using a second communication standard that involves a base station;
a display configured to display information to a user; and
a terminal controller; and
a control server comprising:
a server communicator configured to perform communication using the second communication standard, wherein
the vehicle controller is configured to, in response to detection of an abnormality in the vehicle, transmit abnormality information on the abnormality in the vehicle from the vehicle communicator to the first terminal communicator of the mobile communication terminal registered as being paired with the in-vehicle device, and
the terminal controller is configured to, in response to receipt of the abnormality information from the in-vehicle device, cause the display to display information extracted from the abnormality information, and transmit the abnormality information from the second terminal communicator to the server communicator.

2. The information communication system for the vehicle according to claim 1, wherein
the abnormality information comprises an error code, and
the terminal controller is configured to cause the display to display a search screen that allows a search for detailed information corresponding to the error code.

3. The information communication system for the vehicle according to claim 1, wherein
the terminal controller is configured to attach information for identifying the mobile communication terminal to the abnormality information when transmitting the abnormality information from the second terminal communicator to the server communicator.

4. The information communication system for the vehicle according to claim 3, wherein
the control server further comprises a server controller,
the server controller is configured to transmit an analysis result that is based on the abnormality information, from the server communicator to the second terminal communicator, and
the terminal controller is configured to cause the display to display the analysis result received from the control server.

5. An information communication system for a vehicle, the information communication system comprising:
an in-vehicle device comprising:
a vehicle communication device configured to perform communication using a first communication standard that does not involve any base station; and
a vehicle processor;
a mobile communication terminal comprising:
a first terminal communication device configured to perform communication using the first communication standard;
a second terminal communication device configured to perform communication using a second communication standard that involves a base station;
a display device configured to display information to a user; and
a terminal processor; and
a control server comprising:
a server communication device configured to perform communication using the second communication standard, wherein
the vehicle processor is configured to, in response to detection of an abnormality in a vehicle, transmit abnormality information on the abnormality in the vehicle from the vehicle communication device to the first terminal communication device of the mobile communication terminal registered as being paired with the in-vehicle device, and
the terminal processor is configured to, in response to receipt of the abnormality information from the in-vehicle device, cause the display device to display information extracted from the abnormality information, and transmit the abnormality information from the second terminal communication device to the server communication device.
